(19) United States
(12) Patent Application Publication
(10) Pub. No.: US 2002/0133366 A1
(43) Pub. Date: Sep. 19, 2002

(54) Problem joint system for facilitating problem-solving

(75) Inventors: Kouichi Tsuchimura, Kawasaki (JP); Kouji Saimi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/906,058

(22) Filed: Jul. 17, 2001

(30) Foreign Application Priority Data
Mar. 16, 2001 (JP) 2001-76322

(51) Int. Cl. G06F 17/60

(52) U.S. Cl. 705/1

(57) ABSTRACT

A problem joint system is provided for sharing problems in a service. The system includes a problem data enroller which transmits a problem registration form to terminals for acquiring problem data, and a problem data organizer which organizes the acquired problem data.

### BACKGROUND OF THE INVENTION

1. Field of the invention

The present invention relates to a problem joint system for effective solution of business problems encountered in product distribution markets or service industries. The present invention also relates to computers and computer programs used for such a problem joint system.

2. Description of the Related Art

A condominium or house is usually one of the biggest purchases we make. Naturally, we hope to buy ones as good as possible. However, we often cannot know that a condominium has defects or problems (e.g. damaged equipments or error in design) until we actually live in it. When a resident has found a problem with his (or her) condominium, there may be two ways to complain. One is “direct complaining” whereby the resident in person makes a complaint to the selling agency of the condominium. The other is “indirect complaining” whereby the resident reports to the condominium body corporate about the problem, and requests the corporate to make a complaint to the selling agency. In either case, however, the negotiation between the resident (or the body corporate) and the selling agency tends to end up with the winning of the selling agency since, in power relationship, the selling agency is usually much stronger than one individual (resident) or one association (body corporate).

In addition, an ordinary resident of the condominium usually lacks in technical knowledge to grasp the gist of the structural problem. Thus, it is easy for the selling agency (which may well have acquired expertise) to dodge the complaint of the resident cunningly, and to convince him that his problem is nothing serious or that they are not responsible for the problem. Consequently, the problem of the poor resident will remain unsolved, and he may be destined to endure it for a long time or forever.

The same inconvenience as stated above may happen in purchasing a car, foods, etc. or in receiving a medical service (one weak patient vs. big hospital).

### SUMMARY OF THE INVENTION

The present invention has been proposed under the circumstance described above. It is, therefore, an object of the present invention to provide a problem joint system by which the same or similar problems encountered by different people are collected in one place (database) to be organized. This organized data is accessible to a wide variety of people, while also being automatically transmitted to professional property advisers (such as registered architectures and lawyers). In this manner, a problem can be shared among a plurality of persons suffering from the same problem, which helps them to be united against the common selling agency (a plurality of residents vs. one selling agency). Besides, it is also possible for the residents to obtain professional advice, comments, suggestions, etc. from the property advisers. This helps the residents to negotiate with the selling agency in their favor.

According to a first aspect of the present invention, there is provided a problem joint system for sharing problems in a service. The system includes a problem data enroller which transmits a problem registration form to terminals for acquiring problem data, and a problem data organizer which organizes the acquired problem data.

Preferably, the terminals may be operated by a contracted recipient of the service and an intended recipient of the service.

Preferably, the system of the present invention may further include a first problem data transmitter which transmits the organized problem data to a terminal operated by a provider of the service.

Preferably, the system of the present invention may further include a second problem data transmitter which transmits the organized problem data to a terminal operated by a problem-solving adviser.

Preferably, the system of the present invention may further include a reply enroller which receives a reply supplied from one of the service provider and the problem-solving adviser, wherein the reply is made in response to the transmission of the organized problem data.

Preferably, the system of the present invention may further include a reply viewer which allows the recipient of the service to access the reply.

Preferably, the system of the present invention may further include a problem data viewer which allows a potential recipient of the service to access the organized problem data.

Preferably, the problem data enroller, the problem data organizer, the first problem data transmitter and the second problem data transmitter may be managed by a managing agency independent of the service provider and the problem-solving adviser.

According to a second aspect of the present invention, there is provided a computer for sharing problems in a service. The computer includes a problem data enroller which transmits a problem registration form to terminals for acquiring problem data, and a problem data organizer which organizes the acquired problem data.

According to a third aspect of the present invention, there is provided a program for controlling a computer for sharing problems in a service. The program includes a data enrolling program which causes the computer to transmit a problem registration form to terminals for acquiring problem data, and a data organizing program which causes the computer to organizes the acquired problem data.

Other features and advantages of the present invention will become apparent from the detailed description given below with reference to the accompanying drawings.

### BRIEF DESCRIPTION OF THE DRAWINGS

FIG. 1 illustrates the basic concept of a problem joint system according to the present invention, wherein the central computer or server is connectable to a plurality of personal computers via the Internet;

FIG. 2 is a block diagram showing the principal components of the server;

FIG. 3 shows the data processing flow of the problem data obtained from the personal terminals;

FIG. 4 illustrates the contents of a problem extraction data file used for the problem joint system;

FIG. 5 illustrates the contents of master files used for the problem joint system;

FIG. 6 illustrates the contents of a problem organization/solution data file used for the problem joint system;

FIG. 7 is a flowchart showing the problem-claiming data registration procedure;

FIG. 8 is a flowchart showing the data totalization procedure;

FIG. 9 is a flowchart showing the automatic data linking procedure;

FIG. 10 is a flowchart showing the reply registration procedure;

FIG. 11 is a flowchart showing the database access procedure; and

FIG. 12 is a flowchart showing the details of the problem statistics or item data searching procedure.

### DETAILED DESCRIPTION OF THE PREFERRED EMBODIMENT

The preferred embodiment of the present invention will be described below with reference to the accompanying drawings.

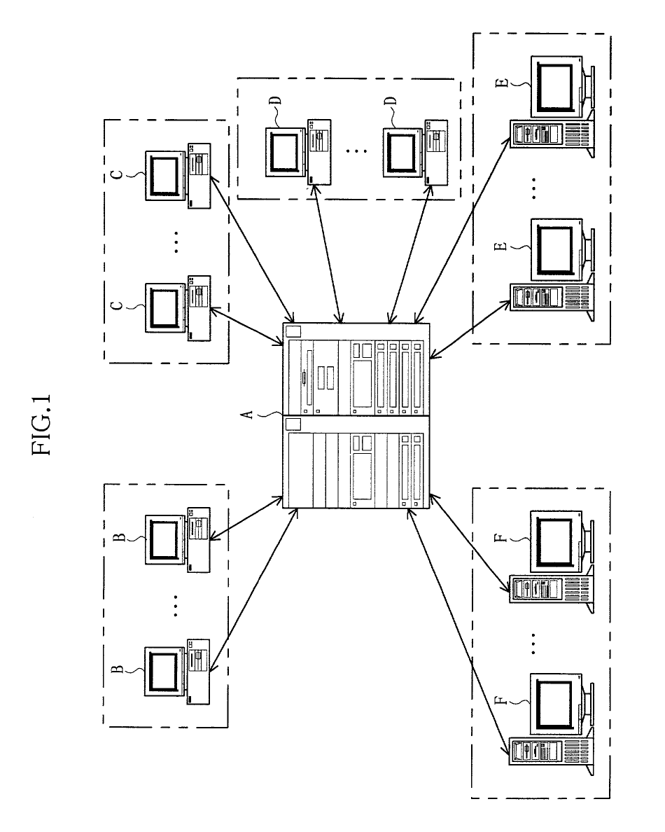

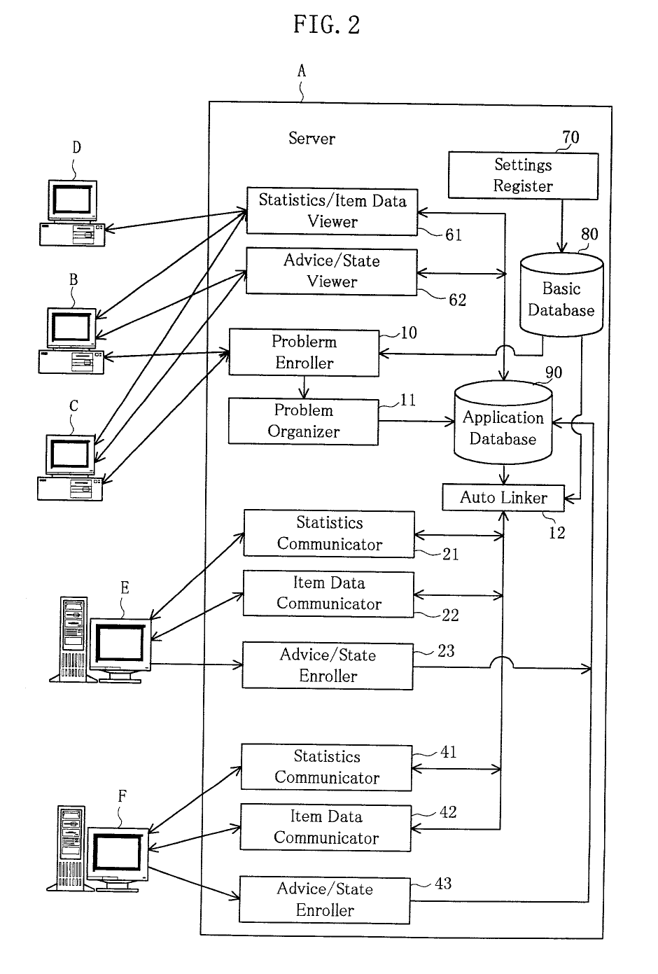

FIGS. 1 and 2 illustrate the concept of a problem joint system according to a preferred embodiment of the present invention. The illustrated embodiment is designed for allowing a plurality of persons to share information about insurance problems or equipment problems of condominiums.

The gist of the illustrated system is as follows. Using their personal computers or portable telephones, the contracted residents and/or intended residents of a condominium can register insurance or equipment problems of the condominium to a central computer (“server”) via the Internet. Here, the “intended residents” refer to ones who have just entered into the provisional contract to buy an apartment of the condominium but not moved into the apartment yet. The problem data (“problem-claiming data”) inputted from the terminals of the contracted or intended residents are classified and totalized by the server, to be turned into “organized problem data.” As will be described in detail later, the organized problem data consists of “problem item data” and “problem statistics data.”

The organized problem data is stored as a database in the server. This registered organized problem data can be accessed by the residents (contracted or intended) of the condominium from their terminals. In this manner, firstly, a contracted resident of the condominium may know that another contracted resident also suffers from the same problem, which helps them to cooperate to solve the problem. Secondly, an intended resident can know what problems the condominium has before he or she moves into the condominium. This helps the intended resident to go into action to solve the problem at an early stage.

The registered organized problem data can also be accessed by potential contractors of the condominium from their terminals. (Here, the “potential contractors” refer to ones who are looking around for a suitable condominium to buy.) In this manner, the potential contractors can know in advance what problems the prospective condominium has. This helps the potential contractors to perform proper decision making whether to buy or not to buy the condominium.

While the organized problem data is registered in the server, as stated above, it will also be automatically transmitted to property investigation agencies (to which registered architectures or lawyers belong) and condominium selling agencies by e.g. E-mail.

Reviewing the transmitted organized problem data, the property investigation agencies may register a reply to the server. The reply, prepared based on business expertise, may contain advice, suggestions or solutions helpful for the inflicted residents to overcome their problems. This registered reply can be accessed by the contracted or intended residents from their terminals.

Likewise, the selling agencies review the automatically transmitted organized problem data. Through this, the selling agencies can know what complaints their customers have against the condominiums of their trade. Further, the selling agencies can register “current state information” to the server from their terminals. This current state information may contain information about a reform measure to be planed in response to the problems claimed by the customers. In addition, the current state information may contain information about how far a reform measure has been carried out. The registered current state information can be accessed by the contracted or intended residents.

Now, the problem joint system of the preferred embodiment will be described in more details.

As shown in FIG. 1, the problem joint system of the present invention includes a central computer or server A and a plurality of terminals B, C, D, E and F which are accessible to the server A via a communications network including the Internet. Typically the terminals B, C, D, E and F are personal computers, but they may be portable telephones provided with E-mail function and other related functions.

In the illustrated embodiment, the terminals B are operated by the contracted residents of a condominium, the terminals C by intended residents, the terminals D by potential contractors, the terminals E by the selling agency of the condominium, and the terminals F by investigation agencies to which professional property advisers (such as registered architects and lawyers) belong to.

The server A may be managed by an agency independent of the residents (contracted or intended), potential contractors, selling agencies and investigation agencies. The illustrated server A functions as a WWW (World Wide Web) server, though the present invention is not limited to this. For instance, the main computer A may only intermediate between the terminals B-F and a separately prepared Internet server.

The server A includes a nonillustrated CPU (central processing unit) serving as the following means. Referring to FIG. 2, the CPU works as a problem enroller 10 accessed by the terminals B or C (contracted or intended residents), a problem organizer 11 and an automatic linker 12. The CPU also serves as a first statistics communicator 21, a first item data communicator 22 and a first advice/state enroller 23. These first components 21-23 are accessed by the terminals E (selling agencies). Likewise, the CPU serves as a second statistics communicator 41, a second item data communicator 42 and a second advice/state enroller 43. These second components 41-43 are accessed by the terminals F (investigation agencies).

Further, the CPU serves as a statistics/item data viewer 61 and an advice/state viewer 62, where the former is accessed by the terminals B, C and D (contracted residents, intended residents, and potential contractors), and the latter by the terminals B and C (contracted and intended residents).

In addition to the above-mentioned CPU, the server A includes a storage device (hard disks) to store a basic database 80 and an application database 90. The basic database 80 contains various settings required for running the system of the present invention. The application database 90 contains problem data to be shared by people concerned, as will be descried later.

The problem enroller 10 is provided for receiving problem-claiming data from a terminal B (contracted resident) or terminal C (intended resident). The problem-claiming data is entered by the operator of the terminal B or C in accordance with a prescribed “problem registration form” transmitted to the terminal B or C based on CGI (Common Gateway Interface) or ISAPI (Internet Server Application Programming Interface). The problem registration form is generated in accordance with a “problem extraction data file” (to be described later). Hereinafter, problem-claiming data inputted through one registration form will be referred to as “1-form” problem-claiming data.

In general, equipment problems of a condominium may be divided into two categories: public problems concerning the properties for common use and private problems concerning the properties of the individual residents. Examples of the public problems may be cracks in the external walls, deteriorated mortar, rain leaking through the roof, rust of the mechanical parking garage, etc. Examples of the private problems may be the exfoliation of the flooring, the growth of mold or stench of the toilet due to an improper ventilation system, ill fitted doors or windows, etc.

The above-mentioned 1-form problem-claiming data may contain only one specific problem (e.g. occurrence of cracks in the external walls) or several specific problems (e.g. rain leaking, broken ventilation system, etc.).

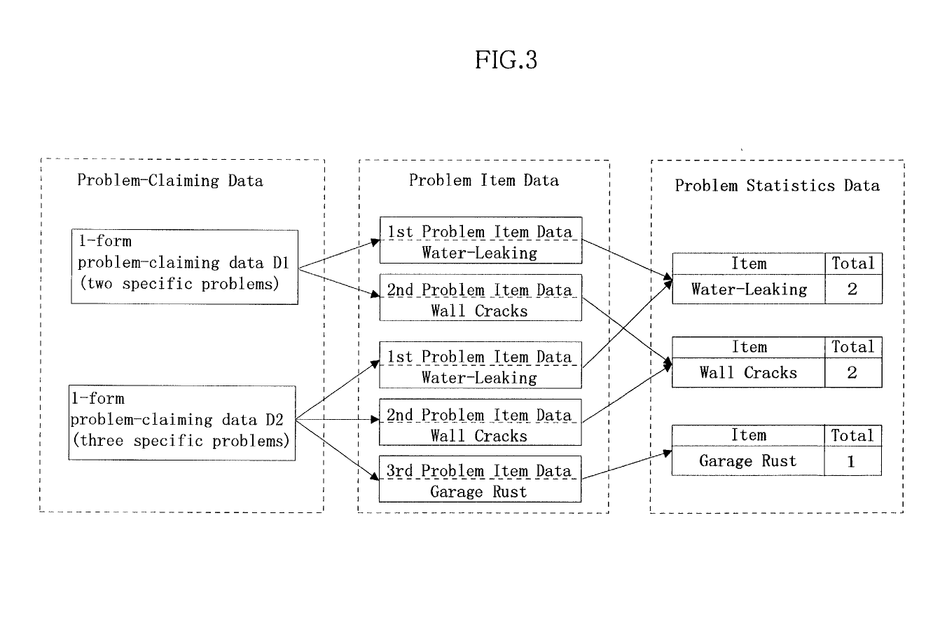

When 1-form problem-claiming data relates to more than one problem, the problem organizer 11 subdivides the problem-claiming data into the corresponding number of pieces of subdata (“problem item data”). For example, referring to FIG. 3, when 1-form problem-claiming data D1 relates to two problems (say, water-leaking and wall cracks), it is subdivided into two pieces of problem item data, wherein a first problem item data may relate to the water-leaking, and the other problem item data may relate to the wall cracks. The subdivided problem item data is added to the application database 90. Likewise, upon receiving another 1-form problem-claiming data D2 relating to three specific problems (say, water-leaking, wall cracks and garage rust), the problem organizer 11 extracts three pieces of problem item data, wherein a first problem item data may relate to the water leaking, a second problem item data may relate to the wall cracks and the last problem item data may relate to the garage rust. This subdivided problem item data is also added to the application database 90.

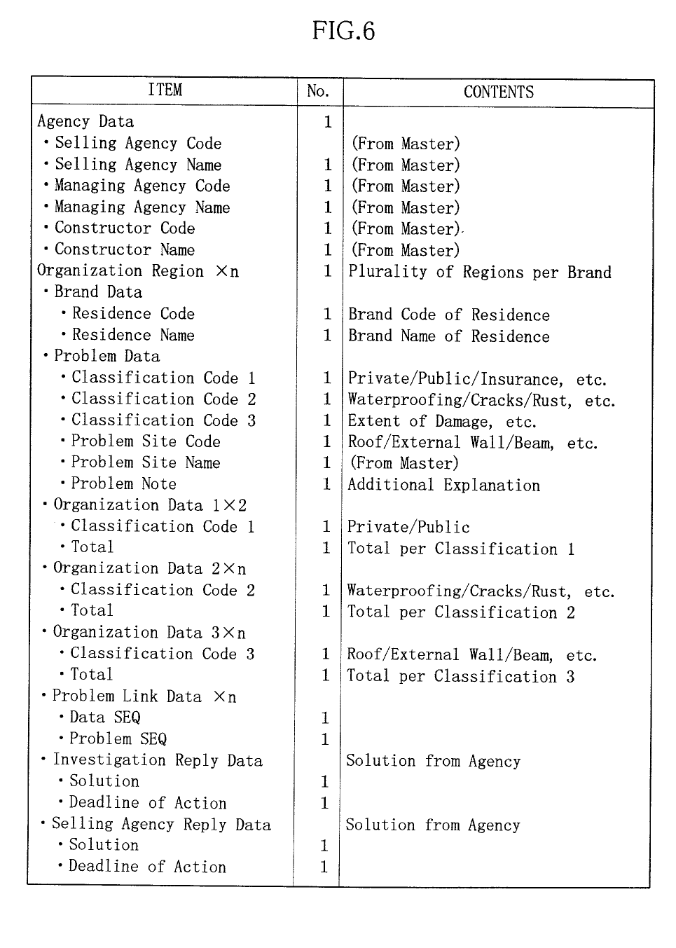

Then, the problem organizer 11 computes the classified totals of all the problem item data, based on a problem organization/solution data file (to be described later with reference to FIG. 6), to provide problem statistics data. As seen from FIG. 3, the problem statistics data shows how many similar or identical problems have been claimed by the contracted or intended residents. The problem statistics data is also added to the application database 90.

The automatic linker 12 is provided for automatically sending the organized problem data (i.e., the problem item data and the problem statistics data) to selected one or ones of the terminals E (selling agencies) or terminals F (investigation agencies). Specifically, when the organized problem data is obtained in the above-described manner, the automatic linker 12 refers to “master files (to be described later)” contained in the basic database 80, so that a selling agency and/or investigation agency competent to deal with each specific problem is specified. Then, the automatic linker 12 causes the statistics communicators 21, 41 or item data communicators 22, 42 to send the problem statistics data or problem item data to the specified agency.

In addition to the above automatic data sending function for the problem statistics data and problem item data, the statistics communicator 21 and item data communicator 22 have the following function. When there is a statistics data query request from a terminal E (selling agency), the statistics communicator 21 accesses the application database 90 to look for the requested data based on CGI or ISAPI. Similarly, the item data communicator 22 accesses database 90 to look for the requested problem item data. The retrieved data is automatically sent back to the terminal E by E-mail.

As readily seen, the second statistics communicator 41 and item data communicator 42 have the same database access function. Specifically, when there is a statistics data query request or problem item data query request from a terminal F (investigation agency), the statistics communicator 41 or item data communicator 42 access the application database 90 to look for the requested data. Again, the retrieved data is automatically sent back to the terminal F by E-mail.

The advice/state enroller 23 or 43 will receive reply data sent from the terminal E or terminal F by E-mail. This reply data contains advice, suggestions, solutions, etc. provided from the selected selling agency or investigation agency in response to the problems automatically transmitted to these agencies before. The reply data is generated in accordance with the problem organization/solution data file. The reply data is added to the application database 90.

The statistics/item data viewer 61 allows the residents (contracted or intended) and potential contractors to have an access to the organized problem data stored in the application database 90. The advice/state viewer 62 allows the residents (contracted or intended) to have an access to the above reply data (professional property advice, solutions or report on the on-going or planned improvements) stored in the application database 90.

The settings register 70 allows the operator of the server A to store required registration forms and master files in the basic database 80.

As stated above, the residents or intended residents of the condominium can input problem-claiming data through a registration form from their terminals. This registration form has a questionnaire format containing a number of prescribed questions regarding e.g. the conditions of the condominium equipments. The questionnaire format is defined by a “problem extraction data file.”

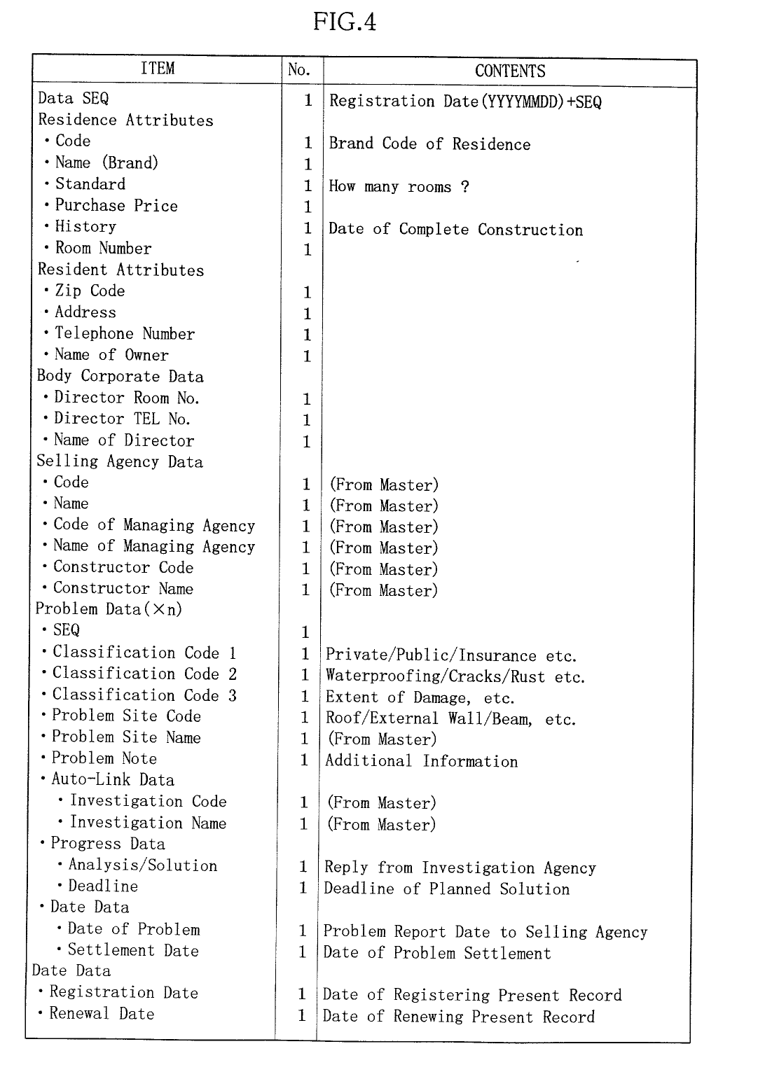

Reference is now made to FIG. 4 illustrating a problem extraction data file used for the problem joint system of the present invention. According to the problem extraction data file, the above-mentioned problem statistics data and the problem item data will contain such information as a data SEQ, structure attribute data, resident attribute data, condominium body corporate data, selling agency data, complaint data, registration/renewal date data, etc.

It should be noted here that the complaint data includes classification code 1 (Categories: private issue, common issue, insurance issue, etc.), classification code 2 (Identification of the problem: water leakage, wall cracks, rust, etc.), classification code 3 (Contents of the problem/Extent of the damage), problem site code, and automatic linkage data which specifies an investigation agency competent for solving the claimed problems. The automatic association data and the registration/renewal data mentioned above will be automatically added when a resident fills in the registration form from his or her personal computer.

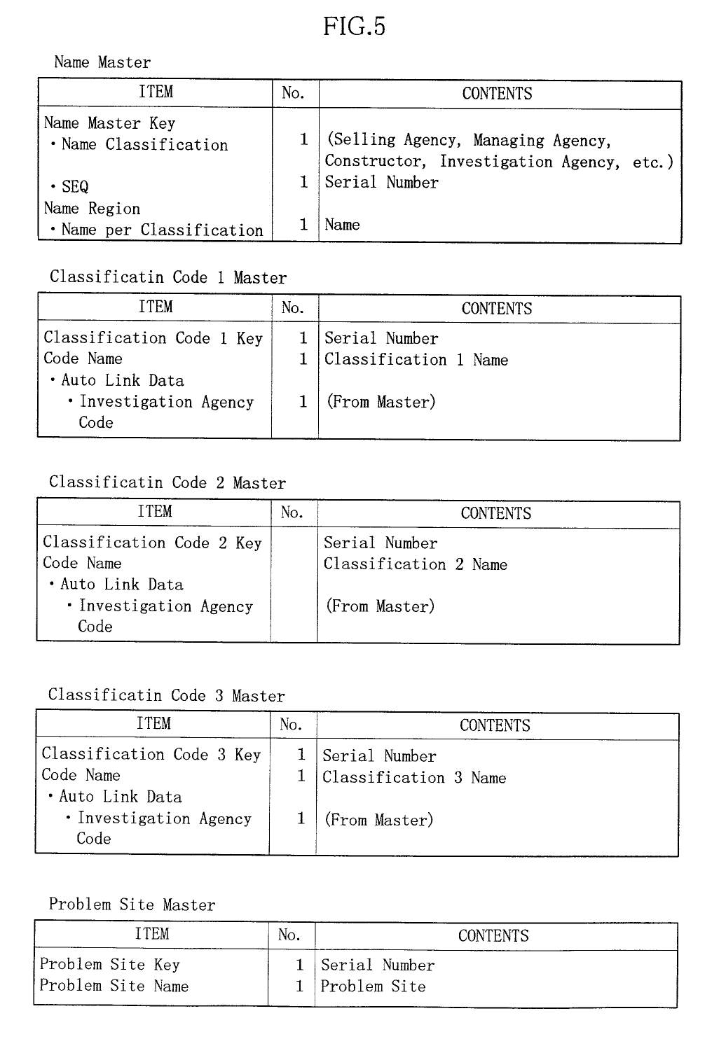

As shown in FIG. 5, the master files include Name Master, Classification Code 1 Master, Classification Code 2 Master, Classification Code 3 Master and Problem Site Master. Name Master is for specifying the preregistered selling agencies or investigation agencies. Classification Code 1 Master (Category Classification Master) is provided for defining relations between private/public/insurance/other problems and agencies competent to cope with these problems. Classification Code 2 Master (Specific Problem Classification Master) is provided for defining relations between waterproofing/cracks/rust, etc. and agencies competent to cope with these problems. Classification Code 3 Master (Phenomenon/Damage Extent Classification Master) is provided for defining relations between phenomenon/damage extent and agencies competent to cope with the problems. Problem Site Master is provided for specifying the spot or place of the occurrence of problems. By referring to these master files, the above-mentioned auto-link information is provided automatically.

Referring to FIG. 6, according to the problem organization/solution data file, selling agency data, brand data, problem data, total-per-classification data, specific problem link data, agency replay data, etc. are to be contained in the problem statistics data or problem organization/solution data. In this manner, the problem item data, the problem statistics data and the problem organization/solution data are linked to each other in the application database 90, so that the operators of the terminals B, C or D can easily retrieve their desired information from the database.

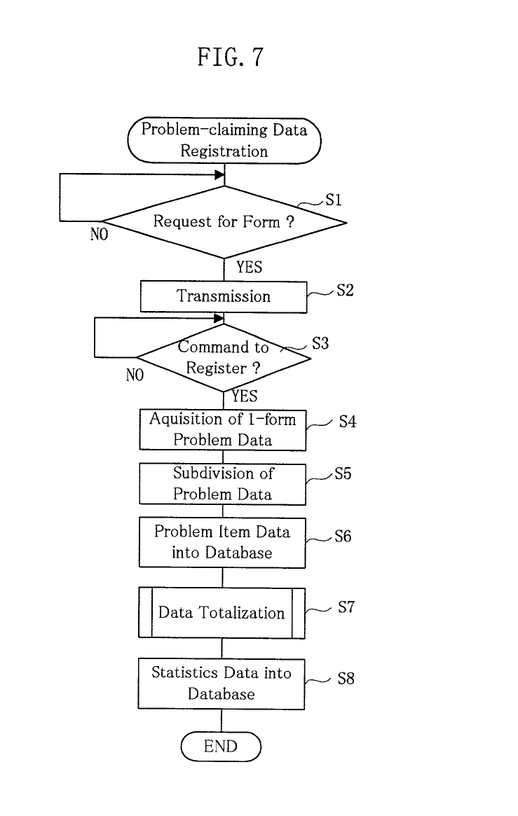

The operations of the server A will now be described with reference to the flowcharts shown in FIGS. 7-12.

The flowchart of FIG. 7 illustrates the problem-claiming data registering procedure performed by the server A. At Step 1, the server A (the CPU of the server, to be precise) determines whether or not a request for a “problem registration form” is issued from a terminal B (contracted resident) or C (intended resident). This request is made by specifying the URL (Uniform Resource Locator) address of the registration form.

When such a request is made (S1:YES), the registration form is read out from the basic database 80 based on the specified address, and then transmitted to the terminal B or C (S2), to be displayed on the monitor of the terminal. The operator of the terminal types in problems of the condominium and other required information in accordance with the registration form.

When no request is issued (S1:NO), the CPU waits for a request to be made.

After the necessary data is inputted according to the registration form, the CPU of the server A determines whether or not a registration request command is issued from the terminal (S3). Upon receiving such a command (S3:YES), the CPU obtains the problem-claiming data as “1-form problem data” (S4).

When there is no command (S3:NO), the CPU waits for a command to be made.

After the 1-form problem data is obtained, the CPU subdivides the data (S5). This generates one or more pieces of data (“problem item data”) each of which relates to one specific problem. Then, all the problem item data is integrated into the application database 90 (S6). Meanwhile, the CPUperforms “classified totalization of data” with respect to the problem item data (S7), thereby providing “problem statistics data.” The detail of the data totalization will be described below.

Finally, the CPU integrates the problem statistics data into the application database 90 (S8).

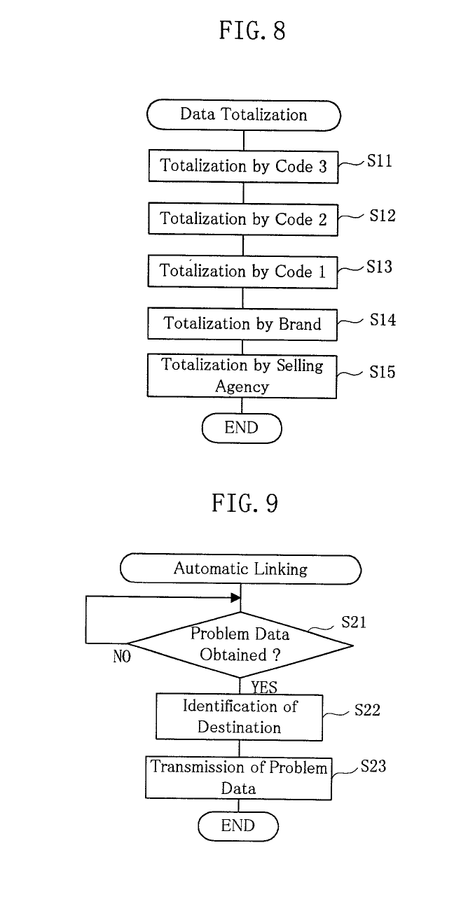

Referring now to FIG. 8, the data totalization (S7 in FIG. 7) is performed in the following manner. At Step 11, the CPU of the server A computes the classified totals of all the problem item data according to the classification code 3. Thus, “problem statistics data by classification code 3” is obtained. In the same manner, the CPU of the server A generates “problem statistics data by classification code 2” and “problem statistics data by classification code 1” (S12, S13). Further, the CPU of the server A generates “problem statistics data by brand classification” (S14), and finally “problem statistics data by selling agency classification” (S15).

Referring to FIG. 9, the flowchart shows the automatic linking process for automatically sending the organized problem data (namely, problem item data and problem statistics data) to a competent selling agency or investigation agency. At Step 21, the CPU of the server A determines whether or not organized problem data is obtained in the above-described problem data registration (FIG. 7).

When organized problem data is obtained (S21:YES), the mail address of a competent selling or investigation agency is specified (S22) to send the obtained data. This mail address specification is achieved with reference to the automatic link data contained in each piece of problem item data.

When no problem data is obtained (S21:NO), the CPU of the server A waits for problem data to be entered.

After the mail address is specified, the organized problem data is transmitted to the specified address (S23).

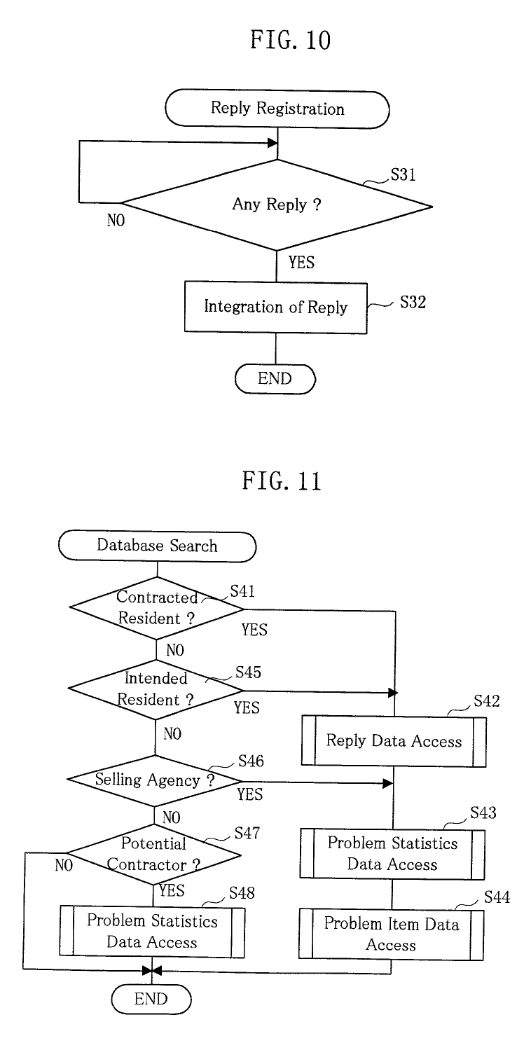

Referring now to FIG. 10, the flowchart shows the process of registering replies provided by the selling or investigation agencies in response to the organized problem data which had been automatically sent. At Step 31, the CPU of the server A determines whether or not such a reply is provided from the selling or investigation agency by E-mail.

When there is such a reply (S31:YES), the CPU of the server A integrates the reply into the application database 90 (S32). When there is no reply (S31:NO), the CPU of the server A waits for a reply to be made.

Referring now to FIG. 11, the flowchart shows the database searching process. At Step 41, the CPU of the server A determines whether or not a request for searching the application database 90 is made from a terminal B (contracted resident).

When such a request is made (S41:YES), the CPU of the server A allows the terminal B to access the application database 90 for retrieval of desired information (S42). More specifically, when the contracted resident (terminal B) makes a request for access to the application database 90, the CPU of the server A transmits a prescribed “search form” to the terminal B. The search form may prompt the contracted resident to enter some key words needed to find the desired information. Then, when the key words are correctly entered by the resident, they are transmitted to the server A. Finally, the desired information is read out from the database 90, and transmitted to the terminal B.

In the procedure illustrated in FIG. 11, the resident or operator of the terminal B is first allowed to search the reply data provided by the investigation or selling agency (S42), and then the problem statistics data (S43) and the specific problem data (S44). However, the present invention is not limited to this, and the data accessing order may be changed. For security of information, it may be preferable that the operator of the terminal is required to enter his or her own identification number or password before an access to the database is allowed.

When the search request is not issued from a contracted resident (S41;NO), the CPU of the server A determines whether or not it is from an intended resident (S45). When “YES”, the CPU allows the intended resident to proceed into the database access procedures S42, S43 and S44.

When “NO” at Step 45, the CPU of the server A determines whether or not it is from a selling agency (S46).

When “YES” at Step 46, the CPU of the server A permits the database access procedures S43 and S44. Though not shown in the flowchart, an investigation agency can also be allowed the database access procedures S43 and S44 in the same manner.

When a potential contractor makes a request for database search (S47:YES), the CPU of the server A permits access to the problem statistics data only (S48).

When a request for database search is made by an unqualified person who is not given any valid ID number or password (NO at Steps 41, 45, 46 and 47), the CPU of the server A does not allow any data access procedures.

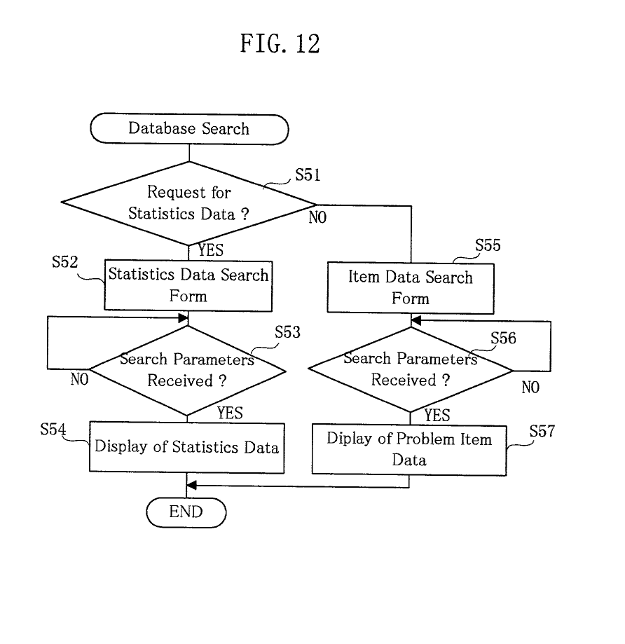

FIG. 12 shows details of the database access procedures S43 and S44 (FIG. 11). As shown, when a request for access to the problem statistics data is made (S51:YES), the CPU of the server A transmits a “statistics data search form” for specifying the desired data (S52). This form prompts the operator of the terminal to enter certain data search parameters (classification codes, the brand, the name of the selling agency, etc.) necessary to locate the desired data.

After the operator of the terminal enters the necessary data and presses the return key, the inputted search parameters are transmitted to the CPU of the server A (S53:YES). Based on this data, the CPU searches the application database 90 to find the desired problem statistics data. The retrieved information will be displayed on the monitor of the terminal (S54). When the database 90 contains no statistics data corresponding to the inputted search parameters, the CPU of the server A will send a message to that effect (“Inquired Data Not Found” for example) to the terminal.

When “NO” at Step 51, the CPU of the server A transmits a “item data search form” for specifying the desired data (S55). According to this form, data search parameters, such as classification codes, the brand, the name of the selling agency, resident attribution data and data registration date are to be entered.

After the operator of the terminal enters the necessary data and presses the return key, the inputted search parameters are transmitted to the CPU of the server A (S56:YES). Based on this data, the CPU searches the application database 90 to find the required problem item data. The results of this search will be displayed on the monitor of the terminal (S57). When the database 90 contains no specific data corresponding to the inputted search parameters, the CPU of the server A will send a message (“Inquired Data Not Found”) to the terminal.

In the preferred embodiment described above, only the condominium residents (contracted or intended), the potential contractors, the selling agencies and the investigation agencies are involved. However, the present invention is not limited to this. For instance, a condominium body corporate and a managing agency may be involved in the system. Here, the “condominium body corporate” may refer to a private association of the condominium residents which may be represented by some elected people to negotiate with the selling agency or some other agencies about the problems of the condominium. The “managing agency” may refer to a subsidiary of the selling agency that is responsible for maintenance of the condominium facilities.

Further, in the preferred embodiment, the present invention is applied to a condominium distribution market, though this is not limitative. For instance, the present invention is applicable to a distribution market of other products (cars, foods, etc.) and also to a service industry (e.g. medical industry).

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A problem joint system for sharing problems in a service, the system comprising:
a problem data enroller which transmits a problem registration form to terminals for acquiring problem data; and
a problem data organizer which organizes the acquired problem data.

2. The system according to claim 1, wherein the terminals are operated by a contracted recipient of the service and an intended recipient of the service.

3. The system according to claim 1, further comprising a first problem data transmitter which transmits the organized problem data to a terminal operated by a provider of the service.

4. The system according to claim 3, further comprising a second problem data transmitter which transmits the organized problem data to a terminal operated by a problem-solving adviser.

5. The system according to claim 4, further comprising a reply enroller which receives a reply supplied from one of the service provider and the problem-solving adviser, the reply being made in response to the transmission of the organized problem data.

6. The system according to claim 5, further comprising a reply viewer which allows the recipient of the service to access the reply.

7. The system according to claim 6, further comprising a problem data viewer which allows a potential recipient of the service to access the organized problem data.

8. The system according to claim 4, wherein the problem data enroller, the problem data organizer, the first problem data transmitter and the second problem data transmitter are managed by a managing agency independent of the service provider and the problem-solving adviser.

9. A computer for sharing problems in a service, the computer comprising:
a problem data enroller which transmits a problem registration form to terminals for acquiring problem data; and
a problem data organizer which organizes the acquired problem data.

10. A program for controlling a computer for sharing problems in a service, the program including:
a data enrolling program which causes the computer to transmit a problem registration form to terminals for acquiring problem data; and
a data organizing program which causes the computer to organizes the acquired problem data.
